(19) United States
(12) Patent Application Publication
(10) Pub. No.: US 2017/0148082 A1
(43) Pub. Date: May 25, 2017

(54) SYSTEM AND METHOD FOR CREATING INTERACTIVE PERSONALIZED VIRTUAL STORES

(71) Applicant: Cognizant Technology Solutions India Pvt. Ltd., Chennai (IN)

(72) Inventors: Jaisri Murahari, Malvern, PA (US); Rucha Joshi, Pune (IN)

(21) Appl. No.: 15/009,281

(22) Filed: Jan. 28, 2016

(30) Foreign Application Priority Data
Nov. 24, 2015 (IN) 6308/CHE/2015

(51) Int. Cl. G06Q 30/06

(52) U.S. Cl. CPC G06Q 30/0631; G06Q 30/0643

(57) ABSTRACT

A system, computer-implemented method and computer program product for creating one or more personalized interactive virtual stores. The system comprising an offline data creation module configured to generate a virtual store layout and fill information corresponding to one or more products into the generated virtual store layout to generate a virtual store. The system further comprising a gamification module configured to facilitate one or more customers to personalize, via an electronic communication device, the generated virtual store through gamification. Furthermore, the system comprises a mapping module configured to analyze changes in the personalized virtual store to provide real-time personalized recommendations to the one or more customers.

### FIELD OF THE INVENTION

The present invention relates generally to virtual stores in retail industry. More particularly, the present invention provides a system and method for creating one or more interactive personalized virtual stores.

### BACKGROUND OF THE INVENTION

Over the last few years, there has been a tremendous growth in electronic commerce (e-commerce). Most retail enterprises have virtual stores for allowing customers to shop online using their mobile devices. With such tremendous growth, ever-increasing competition and demanding customers, retailers are trying their best to offer utmost online shopping experience to expand customer base and retain existing customers.

Conventionally, various systems and methods exist for creating virtual stores. For example, most retailers have virtual stores in the form of e-commerce websites and mobile applications that customers browse for online shopping. However, these existing e-commerce websites and mobile applications have standard product categories and features which render them unattractive and hardly offer any personalization. Moreover, browsing through various product categories is cumbersome and completely different from shopping in a physical store. Some retailers provide extra dimensional view that are similar in layout to physical store. However, these virtual stores also suffer from similar drawbacks. These virtual stores also require customers to browse through various product categories and brands that may not be of any interest to the customer. Also, these virtual stores offer limited personalization based on customers' purchasing history and interest but do not allow intuitive and real-time personalization.

In light of the abovementioned disadvantages, there is a need for a system and method for creating one or more interactive personalized virtual stores. Further, there is a need for a system and method that creates a virtual store based on customer's demographics, psychology, loyalty, purchase history and preferences. Furthermore, there is a need for a system and method that allow customers to personalize their virtual stores and arrange products based on their needs, preferences and interests in real-time and be informed of the new products and services that retailer has to offer. Also, there is a need for a system and method that allows sharing of the personalized virtual store of a customer with other customers or potential customers by integrating with existing social networking platforms.

### SUMMARY OF THE INVENTION

A system, computer-implemented method and computer program product for creating one or more personalized interactive virtual stores. The system comprising an offline data creation module configured to generate a virtual store layout and fill information corresponding to one or more products into the generated virtual store layout to generate a virtual store. The system further comprising a gamification module configured to facilitate one or more customers to personalize, via an electronic communication device, the generated virtual store through gamification. Furthermore, the system comprises a mapping module configured to analyze changes in the personalized virtual store to provide real-time personalized recommendations to the one or more customers.

In an embodiment of the present invention, the system further comprises a social networking module configured to facilitate the one or more customers to share the personalized virtual store with other users via one or more social networking platforms. In an embodiment of the present invention, the generated virtual store layout comprise one or more empty aisles and shelves. In an embodiment of the present invention, the one or more empty aisles comprise one or more retailer controlled aisles and one or more customizable aisles. In an embodiment of the present invention, filling information corresponding to the one or more products into the generated virtual store layout comprise populating the one or more retailer controlled aisles with one or more products based on one or more factors corresponding to the one or more customers. In an embodiment of the present invention, the one or more factors corresponding to the one or more customers comprise at least customer's segment, customer's interests, browsing history, purchase history and browsing pattern. In an embodiment of the present invention, personalizing the generated virtual store through gamification comprise personalizing the one or more customizable aisles by the one or more customers. In an embodiment of the present invention, personalizing the one or more customizable aisles by the one or more customers comprise at least naming shelves, adding a product or a group of products from various product categories to shelves, deleting products from shelves, rating products and rearranging products on shelves. In an embodiment of the present invention, the personalized recommendations are provided by modifying the one or more retailer controlled aisles in real-time. In an embodiment of the present invention, facilitating the one or more customers to personalize the generated virtual store through gamification comprises rendering the generated virtual store as a game on the electronic communication device and providing one or more options to the one or more customers to interact with the rendered virtual store.

The computer-implemented method for creating one or more personalized interactive virtual stores, via program instructions stored in a memory and executed by a processor, comprises generating a virtual store layout. The computer-implemented method further comprises filling information corresponding to one or more products into the generated virtual store layout to generate a virtual store. Furthermore, the computer-implemented method comprises facilitating one or more customers to personalize, via an electronic communication device, the generated virtual store through gamification. Also, the computer-implemented method comprises analyzing changes in the personalized virtual store to provide real-time personalized recommendations to the one or more customers.

In an embodiment of the present invention, the computer-implemented method further comprises the step of sharing the personalized virtual store with other users via one or more social networking platforms.

The computer program product for creating one or more personalized interactive virtual stores comprises a non-transitory computer-readable medium having computer-readable program code stored thereon, the computer-readable program code comprising instructions that when executed by a processor, cause the processor to generate a virtual store layout. The processor further fills information corresponding to one or more products into the generated virtual store layout to generate a virtual store. Furthermore, the processor facilitates one or more customers to personalize, via an electronic communication device, the generated virtual store through gamification. In addition, the processor analyzes changes in the personalized virtual store to provide real-time personalized recommendations to the one or more customers.

### BRIEF DESCRIPTION OF THE ACCOMPANYING DRAWINGS

The present invention is described by way of embodiments illustrated in the accompanying drawings wherein:

FIG. 1 is a block diagram illustrating a system for creating one or more personalized interactive virtual stores, in accordance with an embodiment of the present invention;

FIG. 2 is a flowchart illustrating a method for creating one or more personalized interactive virtual stores, in accordance with an embodiment of the present invention; and

FIG. 3 illustrates an exemplary computer system for creating one or more personalized interactive virtual stores, in accordance with an embodiment of the present invention.

### DETAILED DESCRIPTION OF THE INVENTION

A system and method for creating one or more interactive personalized virtual stores is described herein. The invention provides for a system and method that creates a virtual store based on customer's demographics, psychology, loyalty, purchase history and preferences. Further, the invention provides for a system and method that allow customers to personalize their virtual stores based on their needs, preferences and interests in real-time. Furthermore, there is a need for a system and method that allows sharing of a customer's personalized virtual store with other customers by integrating with existing social networking platforms. Also, there is a need for a system and method that provides an opportunity to the customers to earn rewards for promoting their personalized virtual stores.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

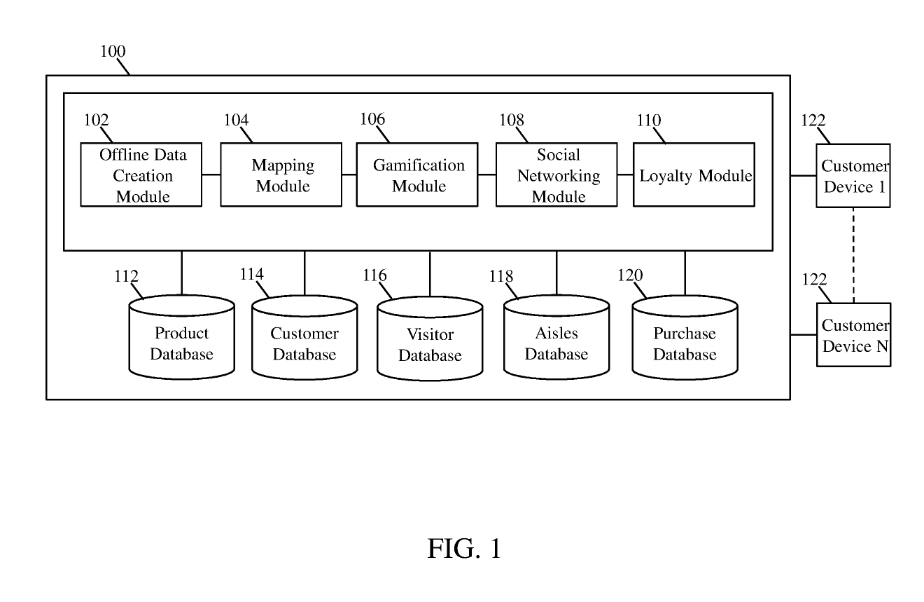

FIG. 1 is a block diagram illustrating a system for creating one or more personalized interactive virtual stores, in accordance with an embodiment of the present invention. The system 100 comprises an offline data creation module 102, a mapping module 104, a gamification module 106, a social networking module 108, a loyalty module 110, a product database 112, a customer database 114, a visitor database 116, an aisles database 118 and a purchase database 120. In an embodiment of the present invention, the system 100 communicates with one or more customer devices 122 via internet to facilitate one or more customers to shop online. The one or more customer devices 122 include electronic communication devices such as, but not limited to, a laptop, a desktop, a mobile phone and a tablet.

The offline data creation module 102 is configured to generate a virtual store layout. In an embodiment of the present invention, the offline data creation module 102 generates the virtual store layout as one or more website wireframes. In an embodiment of the present invention, the virtual store layout comprises of empty aisles and shelves. Further, the one or more empty aisles comprise one or more retailer controlled aisles and one or more customizable aisles. In an embodiment of the present invention, a pre-defined number of aisles and corresponding shelves are customizable by the customer and others are populated by retailer. The aisles and shelves controlled by the retailer are placed with products relevant to the customer. Further, the recommendation of products for the retailer controlled aisles is managed by the mapping module 104 in real-time.

In an embodiment of the present invention, the offline data creation module 102 along with the mapping module 104 fills information related to products into the created virtual store layout to generate a virtual store for new customers as well as existing customers. The information related to the products comprises, but not limited to, product category, sub category, item, item price, product availability, physical store location, product rating, deals and discounts retrieved from the product database 112. In an embodiment of the present invention, filling information related to the products into the created virtual store layout comprises placing one or more products in an efficient manner on aisles and shelves of the created virtual store layout.

In an embodiment of the present invention, the offline data creation module 102 identifies super sub product categories by determining popular product groupings and corresponding products. Further, the popular product groupings and corresponding products are determined by comparing purchase count of each product category with average purchase count retrieved from the product database 112 and the purchase database 120. In an embodiment of the present invention, the product database 112 and the purchase database 120 communicate with an existing product data management platform (not shown) and/or a product catalogue (not shown) and an e-commerce platform (not shown) to retrieve and store information corresponding to the products, their price, promotions and other relevant information deployed and managed by the retailer. The offline data creation module 102 also facilitates one or more copywriters to create titles and taglines for popular product groupings via a user interface (not shown).

In an embodiment of the present invention, the virtual store for existing customers is pre-stored based on the customer's previous visits and interactions with the virtual store. When the customer logs in, the aisle and shelves data for the retailer controlled aisles and customizable aisles is retrieved from the aisles database 118. The customizable aisles are populated as saved by the customer during previous visit. The retailer controlled aisles are populated with products based on the one or more factors corresponding to each of the one or more customers. The one or more factors corresponding to each of the one or more customers include, but not limited to, customer segment, customer's interests, browsing history, purchase history, and browsing pattern.

In an embodiment of the present invention, the offline data creation module 102 comprises various algorithms to determine relevant products to be rendered in shelves on the virtual store. In an embodiment of the present invention, the offline data creation module 102 comprises a “customer segment to product super sub category mapping” algorithm to determine most relevant products for a particular customer segment. During operation, the offline data creation module 102 identifies frequently purchased products and frequently browsed products for various customer segments. Further, the customer segments are determined based on demographic information corresponding to each of the one or more customers stored in the customer database 114. Furthermore, the frequently purchased products and frequently browsed products are identified by analyzing data related to the products stored in the product database 112. In an embodiment of the present invention, data related to the products stored in the product database 112 include, but not limited to, product category, sub category, item, item price, product availability, store location, product rating, deals and discounts. The offline data creation module 102 assigns affinity score for each identified product based on Recency, Frequency and Monetary (RFM) analysis and determines relevant product categories and corresponding products for each customer segment based on the assigned affinity score.

After mapping product category to customer segment, the offline data creation module 102 uses a “product category to individual customer mapping” algorithm. During operation, the algorithm determines product categories that the customer frequently browses using visitor data stored in the visitor database 116. In an embodiment of the present invention, the visitor database 116 stores information such as, but not limited to, number of clicks, visits, referrals and social shares by each of the one or more customers. The algorithm also determines the customer segment to which the customer belongs to determine the product categories relevant to the corresponding segment. The offline data creation module 102 thereby determines relevant product categories and corresponding products for each of the one or more customers. In an embodiment of the present invention, the information related to the one or more aisles and product placement on the one or more aisles of each of the one or more virtual stores corresponding to each customer is stored in the aisles database 118.

The mapping module 104 is configured to facilitate communication with the one or more customer devices 122 and manage and control personalization of the virtual store. In an embodiment of the present invention, the mapping module 104 facilitates the one or more customers to access the virtual store by providing authentication details. The mapping module 104 verifies the provided authentication details. On successful verification, the mapping module 104 renders the virtual store corresponding to the customer on his customer device 122.

In an embodiment of the present invention, the mapping module 104 communicates with the gamification module 106 to render the virtual store as a game on the customer device 122. Further, the gamification module 106 provides one or more options to facilitate customer interaction and personalization of the rendered virtual store. The gamification module 106 is configured to facilitate the one or more customers to access their virtual store to personalize customizable aisles by naming the shelves, adding a product or a group of products from various product categories to shelves, delete products from shelves, browse products, review products, view past purchases, make purchases, view dashboard/timeline, rating products on one or more shelves and moving products in the customizable aisles. In an embodiment of the present invention, the gamification module 106 allows the customer to personalize the virtual store by modifying the one or more customizable aisles. For example, the customer may personalize a customizable aisle by renaming, placing and arranging shortlisted products from a search as per the customer's preference in customizable shelves. The gamification module 106 also facilitates leveling up and awarding badges and reward points based on customer activities such as, but not limited to, purchasing, browsing and promoting the personalized virtual store.

The gamification module 106 is further configured to provide options to the customer to share the personalized virtual store with other users via one or more social networking platforms. In an embodiment of the present invention, the other users include, but not limited to, friends and contacts associated with the customer's social networking accounts on the one or more social networking platforms. The social networking module 108 is configured to interface with the one or more social networking platforms and compute a social score based on the customer's activity to promote the personalized virtual store. In an embodiment of the present invention, the social networking module 108 communicates with the gamification module 106 and renders options to facilitate the one or more customers to promote their personalized virtual stores by posting on their friends social networking accounts and inviting them to visit their personalized virtual stores. The social networking module 108 also provides one or more options to the customer to keep sections of the personalized virtual store private and/or share with selective set of friends. Further, the one or more customers are rewarded when the one or more friends visit their personalized virtual store and/or purchase from the shared virtual store.

The gamification module 106 also communicates with the loyalty module 110 to generate and render a loyalty score for the customer on the customer device 122 based on the customer activity on their personalized virtual store. The loyalty module 110 calculates loyalty earnings based on one or more loyalty parameters such as, but not limited to, net promoter score, number of visits, product/service ratings, brand affinity, sharing of achievements on the one or more social networking platforms, invitations/referrals to friends to create a personalized virtual store account, referrals who converted as customers, number of purchases, monetary value of purchases, number of aisles, number of coupons redeemed and number of visitors to the personalized virtual store. In an embodiment of the present invention, the net promoter score is calculated based on activity of the one or more customers with respect to the one or more social networking platforms. In an embodiment of the present invention, the number of visits by a customer to the personalized virtual store is computed using data from the visitor database 116. Furthermore, number of product/service ratings by the customer is determined using data retrieved from the product database 112 and the purchase database 120.

In an embodiment of the present invention, the mapping module 104 analyses changes in the personalized virtual store made by the customer to recommend products. In an embodiment of the present invention, the recommended products are placed on the one or more retailer controlled aisles. The mapping module 104 comprises a neural network configured to determine one or more products for recommendation based on the customer activity in real-time. In an embodiment of the present invention, the one or more attributes of a product are extracted from the product database 112, customer database 114, visitor database 116, aisles database 118 and purchase database 120. Further, behavior data for each user corresponding to each product is calculated as a batch process and stored. The neural network computes fuzzified set of attributes for each product corresponding to the customer in real-time using the stored behavior data and data from the product database 112, the customer database 114, the visitor database 116, the aisles database 118, and the purchase database 120. The mapping module 104 further computes a relevance function for each product based on the corresponding computed fuzzified set of attributes for each customer. Further, the mapping module 104 applies order filter based on customer history/customer segment to select most relevant products for recommendation using the computed relevance function. In an embodiment of the present invention, the order filter is based on customer's shopping behavior and preferences such as, but not limited to, preference for low price, preference for best deals and other relevant preferences.

In an embodiment of the present invention, the mapping module 104 also recommends products for retailer controlled aisles in real-time based on products placed by the customer on the customizable aisles. The mapping module 104 generates a list of compatible products corresponding to each product in the customizable aisle based on product affinity. The list of compatible products is generated by first identifying related products. The mapping module 104 then identifies frequently browsed and frequently purchased products from product sub categories. The mapping module 104 also identifies products purchased along with the frequently browsed and purchased products. Further, a relevance function corresponding to each product is defined based on the fuzzified set of attributes associated with the customer behavior for that product. The products are then assigned a relevance score using the relevance function for each product in the list. Further, the mapping module 104 applies order filter based on customer history and preference to determine highly recommended products. The order filter may be applied based on customer's preferences, including but not limited to, deals, price or any other customer preferences. In an embodiment of the present invention, the mapping module 104 ensures that products placed in shopping cart and products already on the shelf are not recommended. In an exemplary embodiment of the present invention, if there are 5 products in the shelf, and the shelf has 15 slots; the algorithm will provide 10 other compatible products as recommendations to go along with the 5 products in the shelf. Further, the gamification module 106 will visually indicate the difference between the customer's added products and the recommendations.

The mapping module 104 continuously analyzes customer activity while the customer is accessing the personalized virtual store and intuitively recommends products relevant to the customer based on the analysis until the customer logs out of the personalized virtual store account after shopping or browsing. The mapping module 104 then stores the personalized virtual store of the customer until subsequent visits.

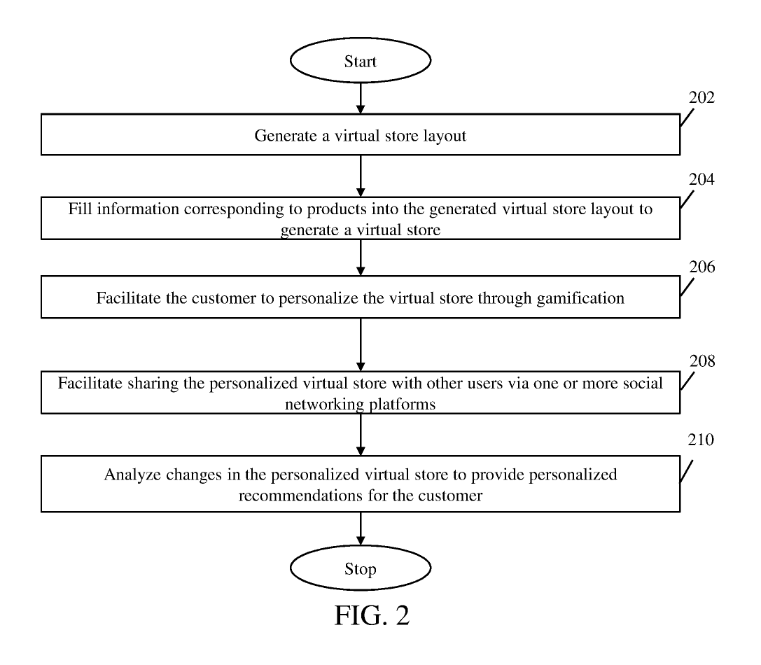

FIG. 2 is a flowchart illustrating a method for creating one or more personalized interactive virtual stores, in accordance with an embodiment of the present invention.

At step 202, a virtual store layout is generated. In an embodiment of the present invention, the virtual store layout is generated as one or more website wireframes. Further, the generated virtual store layout comprises empty aisles and shelves. Further, the one or more empty aisles comprise one or more retailer controlled aisles and one or more customizable aisles. In an embodiment of the present invention, a pre-defined number of aisles and shelves are customizable by customer and others are populated by the retailer. The retailer controlled aisles and corresponding shelves are populated with products relevant to the customer.

At step 204, information corresponding to one or more products is filled into the generated virtual store layout to generate a virtual store. The information related to the products comprises, but not limited to, product category, sub category, item, item price, product availability, physical store location, product rating, deals and discounts. In an embodiment of the present invention, filling information related to the products into the created virtual store layout comprises placing one or more products in an efficient manner on aisles and shelves of the created virtual store layout.

In an embodiment of the present invention, one or more super sub product categories are identified by determining popular product groupings and corresponding products. The popular product groupings and corresponding products are determined by comparing purchase count of each product category with average purchase count retrieved from a product database and a purchase database. In an embodiment of the present invention, a product database and a purchase database communicate with an existing product data management platform and/or a product catalogue and an e-commerce platform to retrieve and store information corresponding to products, their price, promotions and other relevant information deployed and managed by the retailer.

In an embodiment of the present invention, the virtual store for existing customers is pre-stored based on the customer's previous visits and interactions with the virtual store. When the customer logs in, the aisle and shelves data for the retailer controlled aisles and customizable aisles is retrieved from the aisles database. The customizable aisles are in the state as saved by the customer during previous visit. The retailer controlled aisles are populated with products based on the one or more factors corresponding to each of the one or more customers. The one or more factors corresponding to each of the one or more customers include, but not limited to, customer's segment, customer's interests, browsing history, purchase history, and browsing pattern.

In an embodiment of the present invention, various algorithms are used to determine relevant products to be rendered on retailer recommendation shelves in the virtual store. In an embodiment of the present invention, a “customer segment to product super sub category mapping” algorithm is used to determine most relevant products for a particular customer segment. During operation, frequently purchased products and frequently browsed products are identified for various customer segments. Further, the customer segments are determined based on demographic information corresponding to each of the one or more customers stored in a customer database. Furthermore, the frequently purchased products and frequently browsed products are identified by analyzing data related to the products stored in the product database. In an embodiment of the present invention, data related to the products stored in the product database include, but not limited to, product category, sub category, item, item price, product availability, store location, product rating, deals and discounts. Further, an affinity score for each identified product is assigned based on Recency, Frequency and Monetary (RFM) analysis and relevant product categories and corresponding products for each customer segment are determined based on the assigned affinity score.

After mapping product category to customer segment, a “product category to individual customer mapping” algorithm is used for determining product recommendation for the customer. During operation, the algorithm determines product categories that the customer frequently browses using visitor data stored in a visitor database. In an embodiment of the present invention, the visitor database stores information such as, but not limited to, number of clicks, visits, referrals and social shares by each of the one or more customers. The algorithm also determines the customer segment to which the customer belongs to determine the product categories relevant to the corresponding segment.

At step 206, the one or more customers are facilitated to personalize, via one or more customer devices, the virtual store through gamification. The one or more customer devices include electronic communication devices such as, but not limited to, a laptop, a desktop, a mobile phone and a tablet. In an embodiment of the present invention, the one or more customers access their corresponding virtual store by providing authentication details.

In an embodiment of the present invention, the virtual store corresponding to each of the one or more customers is rendered as a game on the one or more customer devices. Further, the one or more customers are provided one or more options to interact with the rendered virtual store. Furthermore, the one or more customers access their virtual store to browse products, review products, view past purchases, make purchases, view dashboard/timeline and personalize customizable aisles of the virtual store by naming shelves, adding a product or a group of products from various product categories to shelves, deleting products from shelves, rating products and rearranging products on shelves. In an embodiment of the present invention, the one or more customers personalize the virtual store by modifying one or more customizable aisles. For example, the customer may personalize a customizable aisle by renaming and placing and arranging shortlisted products as per his preference. The gamification module 106 also facilitates leveling up and awarding badges and reward points based on customer activities such as, but not limited to, purchasing, browsing and promoting the personalized virtual store.

At step 208, the one or more customers are provided one or more options to share the personalized virtual store with other users via one or more social networking platforms. In an embodiment of the present invention, the other users include, but not limited to, friends and contacts associated with the customer's social networking accounts on the one or more social networking platforms. In an embodiment of the present invention, the one or more customers are provided options to promote their personalized virtual stores by posting on their friends social networking accounts and inviting them to visit their personalized virtual stores. Further, the one or more customers are rewarded when the one or more friends visit or shop at their personalized virtual store. In an embodiment of the present invention, a social score corresponding to each of the one or more customers is computed based on the customer's activity to promote the personalized virtual store via the one or more social networking platforms.

At step 210, changes in the personalized virtual stores are analyzed to provide real-time personalized product recommendations to the one or more customers. In an embodiment of the present invention, the personalized recommendations are provided by modifying the one or more retailer controlled aisles in real-time. In an embodiment of the present invention, a neural network is configured to determine one or more products for recommendation based on the customer activity in real-time. Further, the one or more products are recommended based on customer's shopping behavior and preferences. For example, the products are recommended based on price if the customer has a preference to sort products while browsing based on price. In an embodiment of the present invention, products are recommended based on analysis of products placed by the customer on the customizable aisles during personalization and determining corresponding compatible products.

In an embodiment of the present invention, customer activity is continuously analyzed while the customer is accessing the personalized virtual store and products relevant to the customer are intuitively recommended based on the analysis until the customer logs out of the personalized virtual store account after shopping or browsing.

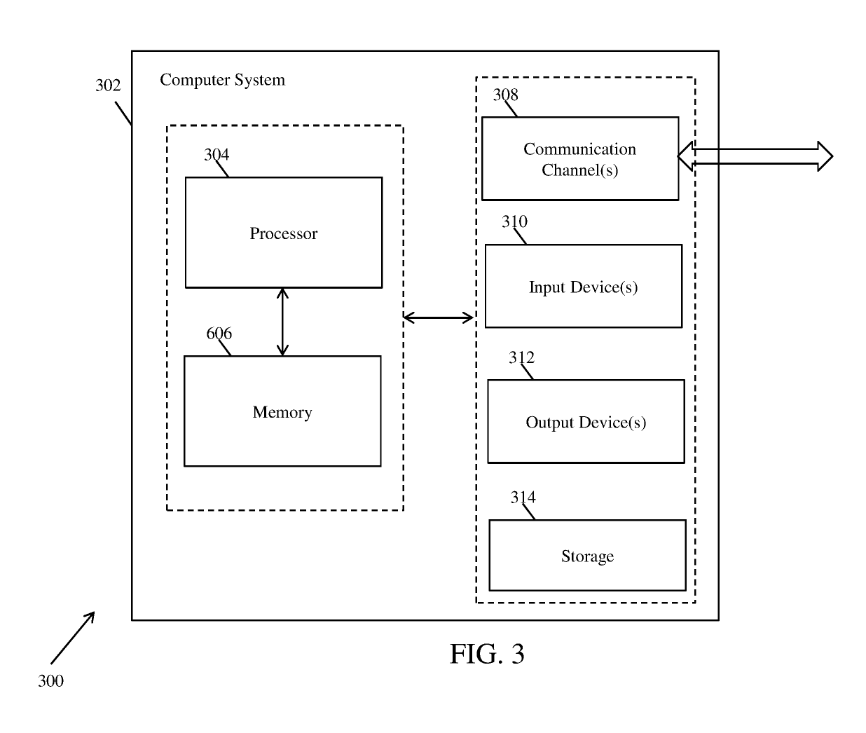

FIG. 3 illustrates an exemplary computer system for creating one or more personalized interactive virtual stores, in accordance with an embodiment of the present invention.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A computer-implemented method for creating one or more personalized interactive virtual stores, via program instructions stored in a memory and executed by a processor, the computer-implemented method comprising:
generating a virtual store layout;
filling information corresponding to one or more products into the generated virtual store layout to generate a virtual store;
facilitating one or more customers to personalize, via an electronic communication device, the generated virtual store through gamification; and
analyzing changes in the personalized virtual store to provide real-time personalized recommendations to the one or more customers.

2. The computer-implemented method of claim 1 further comprising the step of sharing the personalized virtual store with other users via one or more social networking platforms.

3. The computer-implemented method of claim 1, wherein the generated virtual store layout comprise one or more empty aisles and shelves.

4. The computer-implemented method of claim 3, wherein the one or more empty aisles comprise one or more retailer controlled aisles and one or more customizable aisles.

5. The computer-implemented method of claim 4, wherein the step of filling information corresponding to the one or more products into the generated virtual store layout comprise populating the one or more retailer controlled aisles with one or more products based on one or more factors corresponding to the one or more customers.

6. The computer-implemented method of claim 5, wherein the one or more factors corresponding to the one or more customers comprise at least customer's segment, customer's interests, browsing history, purchase history and browsing pattern.

7. The computer-implemented method of claim 4, wherein personalizing the generated virtual store through gamification comprise personalizing the one or more customizable aisles by the one or more customers.

8. The computer-implemented method of claim 7, wherein personalizing the one or more customizable aisles by the one or more customers comprise at least naming shelves, adding a product or a group of products from various product categories to shelves, deleting products from shelves, rating products and rearranging products on shelves.

9. The computer-implemented method of the claim 4, wherein the personalized recommendations are provided by modifying the one or more retailer controlled aisles in real-time.

10. The computer-implemented method of claim 1, wherein facilitating the one or more customers to personalize the generated virtual store through gamification comprises rendering the generated virtual store as a game on the electronic communication device and providing one or more options to the one or more customers to interact with the rendered virtual store.

11. A system for creating one or more personalized interactive virtual stores, the system comprising:
an offline data creation module configured to:
generate a virtual store layout; and
fill information corresponding to one or more products into the generated virtual store layout to generate a virtual store;
a gamification module configured to facilitate one or more customers to personalize, via an electronic communication device, the generated virtual store through gamification; and
a mapping module configured to analyze changes in the personalized virtual store to provide real-time personalized recommendations to the one or more customers.

12. The system of claim 11 further comprising a social networking module configured to facilitate the one or more customers to share the personalized virtual store with other users via one or more social networking platforms.

13. The system of claim 11, wherein the generated virtual store layout comprise one or more empty aisles and shelves.

14. The system of claim 13, wherein the one or more empty aisles comprise one or more retailer controlled aisles and one or more customizable aisles.

15. The system of claim 14, wherein filling information corresponding to the one or more products into the generated virtual store layout comprise populating the one or more retailer controlled aisles with one or more products based on one or more factors corresponding to the one or more customers.

16. The system of claim 15, wherein the one or more factors corresponding to the one or more customers comprise at least customer's segment, customer's interests, browsing history, purchase history and browsing pattern.

17. The system of claim 14, wherein personalizing the generated virtual store through gamification comprise personalizing the one or more customizable aisles by the one or more customers.

18. The system of claim 17, wherein personalizing the one or more customizable aisles by the one or more customers comprise at least naming shelves, adding a product or a group of products from various product categories to shelves, deleting products from shelves, rating products and rearranging products on shelves.

19. The system of the claim 14, wherein the personalized recommendations are provided by modifying the one or more retailer controlled aisles in real-time.

20. The system of claim 11, wherein facilitating the one or more customers to personalize the generated virtual store through gamification comprises rendering the generated virtual store as a game on the electronic communication device and providing one or more options to the one or more customers to interact with the rendered virtual store.

21. A computer program product for creating one or more personalized interactive virtual stores, the computer program product comprising:
a non-transitory computer-readable medium having computer-readable program code stored thereon, the computer-readable program code comprising instructions that when executed by a processor, cause the processor to:
generate a virtual store layout;
fill information corresponding to one or more products into the generated virtual store layout to generate a virtual store;
facilitate one or more customers to personalize, via an electronic communication device, the generated virtual store through gamification; and
analyze changes in the personalized virtual store to provide real-time personalized recommendations to the one or more customers.
